(19) United States
(12) Patent Application Publication
(10) Pub. No.: US 2003/0152670 A1
(43) Pub. Date: Aug. 14, 2003

(54) Food container capable of increasing the effect of air permeability

(76) Inventor: Kuo Shih, Taoyuan (TW)

Correspondence Address: Keith Kline, PRO-TECHTOR INTERNATIONAL SERVICES, 20775 Norada Court, Saratoga, CA, 95070-3018, US

(21) Appl. No.: 10/074,460

(22) Filed: Feb. 11, 2002

(51) Int. Cl. C12C 1/027

(52) U.S. Cl. 426/106

(57) ABSTRACT

The present invention providing a food container capable of increasing the effect of air permeability has a plane jointed side located between a main body and a top cover of an unitarily molded container; a plurality of permeability holes are disposed on the said plane for increasing air permeability of the entire container, accelerating the cold storage and ripening process of the fruit so as to enhance the efficiency and save the laboring time; furthermore, a bottom portion of the said container main body is disposed with a plurality of L-shaped slot holes for draining the water; two sides of the slot holes are disposed with a flange protruding outwardly, a top end thereof is disposed with a convex post protruding outwardly and a concave slot is disposed between two adjacent convex posts to enable an inner and an outer rims of the container main body to form a concavo-convex structure; therefore, the fruit inside the container is not subjected to being touched by the holder's hand portion and cumulating the water so as to prevent rottenness and remain fresh; a convex block is disposed respectively on four corner ends opposite the main body and the top cover of the container; when the top cover is covered onto the main body, the upper and lower convex blocks are superposed together to make the a plurality of hollows between two sides and a front rim of the container thereby to increase the permeability space for the covered container.

### BACKGROUND OF THE INVENTION

1) Field of the Invention

The present invention provides a food container capable of increasing the effect of air permeability, more especially, comprises a jointed side connecting a main body and a top cover of the container is a plane; a plurality of permeability holes are disposed on the said plane for increasing air permeability of the entire food container thereby to more efficiently process the cold storage and ripening of the fruit inside the container.

2) Description of the Prior Art

Accordingly, after being plucked, the green and unripened fruit is placed in a food container to go through a cold storage process for keeping the freshness; before shipping to a fruit dealer or a supermarket for selling, it has to go through a process of accelerating ripeness.

However, the conventional food container, as shown in FIG. 4, has a transparent container main body (100) unitarily molded with a container cover (101), a container body (102) and a jointed side (103) in the middle; wherein a cover plate of the container cover (101) and the bottom plate of the container body (102) are disposed with a plurality of permeability holes (1011, 1021) for generating air convection inside the container main body (100) so as to speed up the time for cold storage and defrosting; most of the permeability holes (1011, 1021) of the plastic-made container main body (100) are on the horizontal top and bottom planes and the vertical side plane is hard to be disposed with holes; furthermore, the permeability holes (1021) on the bottom plane of the container body (102) are adjacent to the bottom layer, the permeability effect thereof is limited; therefore, the permeability of the container main body (100) depends only on the permeability holes (1011) on a single side of the container body (101); that results in not so preferred effect of cold storage and air ripening process of the fruit inside the container main body (100) and too much time consumption.

### SUMMARY OF THE INVENTION

Therefore, the primary objective of the present invention is to provide a food container capable of increasing the effect of air permeability by designing a jointed sides for connecting a main body and a top cover of the container into a plane form; a plurality of permeability holes are disposed on the said plane to keep the permeability of the longitudinal and lateral side of the food container thereby to increase the permeability of the entire container so as to effectively process the cold storage and accelerate the ripeness of the fruit inside the food container for increasing the efficiency and saving the laboring time.

Another objective of the present invention is to provide a food container capable of increasing the effect of air permeability by concavely disposing a plurality of slot holes on a bottom portion on the inner side of the container body for draining the water; two sides of the slot hole are disposed with a flange protruding outwardly, a top end of the slot hole is disposed with a convex post protruding outwardly; a concave slot is disposed between two adjacent convex posts to enable an inner and an outer rims of the container main body to form a concavo-convex structure; therefore, the moisture inside the container main body can be drained by the slot holes and the fruit inside the container will not be bumped or touched by the holder's palm outside the container; therefore, the food inside the container is not subjected to rottenness and can be kept fresh.

Yet another objective of the present invention is provide a food container capable of increasing the effect of air permeability by disposing a convex block on four corner ends of the main body and the bottom end of the top cover; when the top cover is covered onto the container main body, two ends and a front rim of the container form a plurality of hollows to increase the permeability space of the covered container thereby to always keep the fruit inside the container fresh.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is a drawing of an external view of the covered present invention.

FIG. 2 is a drawing of an external view of the opened present invention.

FIG. 3 is an enlarged drawing of a partial structure of the present invention shown in FIG. 2.

FIG. 4 is a drawing of an external view of a covered conventional product.

### DETAILED DESCRIPTION OF THE PREFERRED EMBODIMENTS

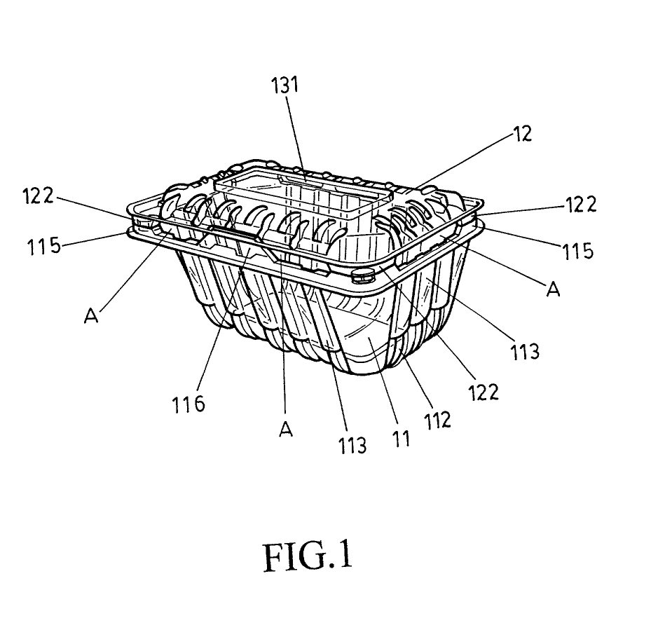

Referring to FIGS. 1-3, the present invention is an unitarily molded plastic container, wherein, a main body (11) and a top cover (12) of the container are connected into one unit by a jointed side (13); a rim side of a top end of the container main body (11) is disposed with a retaining hole (111); a bottom end on the top cover (12) opposite the retaining hole (111) is disposed with a retainer (121); the said retainer (121) can be clamped into the retaining hole (111) for covering the top cover (12) onto the container main body (11).

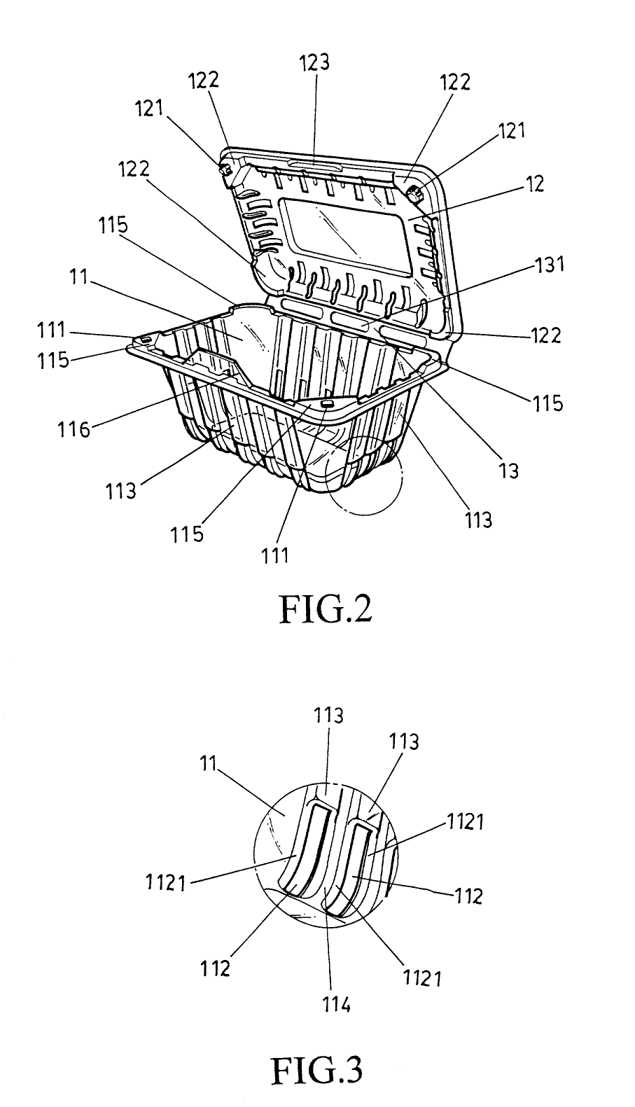

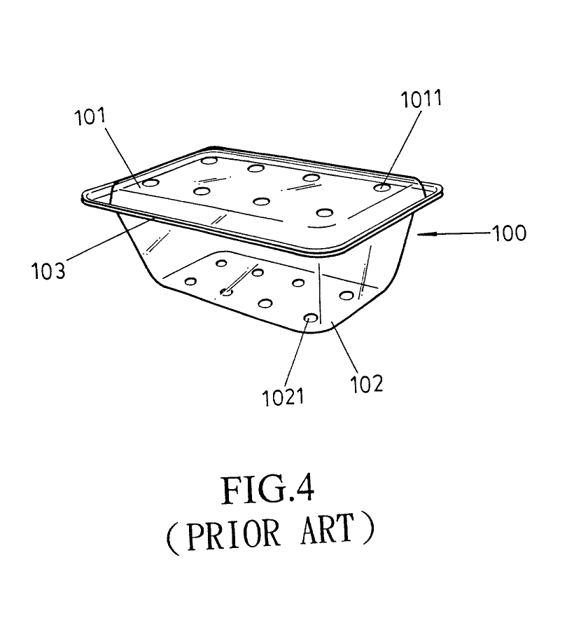

The present invention is characterized that the jointed side (12) connecting the main body (11) and the top cover (12) of the container is a longitudinal plane; a plurality of hollowed permeability holes (131) are disposed on the said plane, as shown in FIG. 2; when the top cover (12) is opened, the plane jointed side (13) is a horizontal plane, not a vertical plane; therefore, it is easy for disposing (compression casting) the permeability holes (131) thereof; when the top cover (12) and the container main body (11) are covered into one unit, as shown in FIG. 1, the plane jointed side (13) forms a lateral plane so as to increase the permeability effect of the entire container; the fruit inside the container main body (11) is subjected to the cold storage or acceleration of the ripeness caused by the air; therefore, efficiency is enhanced and the laboring time is saved.

Furthermore, with a plurality of longitudinal, long and L-shaped like slot holes (112) are disposed around a bottom portion of the container main body (11); two sides of the slot holes (112) are disposed with a flange (1121) protruding outwardly; a top end of the slot hole (112) is disposed with a convex post (113) protruding outwardly; a longitudinal concave slot (114) is disposed between two adjacent convex posts (113) to enable an inner and an outer rims of the container main body (11) to form a concavo-convex structure; a reverse concavo-convex structure is formed on the opposite inner rim of the container main body (11); with the design of the concavo-convex structure, the fruit placed inside the container main body (11) does not tend to be touched by the holder's hand portion; furthermore, the slot holes (112) can drain the left moisture inside the container body (11) outwardly to prevent the fruit therein from contacting the moisture so as to eliminate the rottenness and always keep the fruit fresh.

Furthermore, four end corners at the top ends of the container main body (11) are respectively disposed with a triangular or an arcuate convex block (115); on four end corners at the bottom ends of top cover (12), opposite the area of the convex block (115) of the container main body (11), a triangular or an arcuate convex block (122) is also respectively disposed; when the top cover (12) is covered onto the container main body (11), the upper and the lower convex blocks (122, 115) are superposed together to make two ends and a front rim of the container form a hollow (A), as shown in FIG. 1, for increasing the permeability space of the covered container so as to always keep the fruit inside the container fresh; wherein, the retaining hole (111) of the container main body (11) is located inside the convex block (115) of the front rim; the retainer (121) of the top cover (12) is also located on the convex block (122) of the front rim; at the top end of the container main body (11), a trapezoidal supporting block (116) is disposed at the central portion of the front rim; the said supporting block (116) can be placed inside the receiving slot (123) at the center of the front rim on the bottom portion of the top cover (12), as shown in FIG. 2.

In summation of the abovementioned, the present invention of a food container capable of increasing the effect of permeability mainly comprises a jointed side in a plane form for connecting the main body and the top cover of the container; a plurality of permeability holes are disposed on the said plane to enable the lateral and longitudinal permeability holes to increase the permeability of the entire container for accelerating the cold storage and ripening process of the fruit so as to enhance the efficiency; furthermore, a plurality of slot holes for draining the water disposed on the bottom portion of the container main body and a plurality of hollows disposed on the top end can prevent the fruit and other food from rottenness and always keep them fresh; since the special design of the structure of the present invention isolates the food inside the container from easy touch of the holder's hand portion, the practical effect thereof is doubtless; the present invention has not yet been previously disclosed in application or in any printed documents, complies with the requirements of patent laws and is hereby submitted for a patent application.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A food container capable of increasing the effect of air permeability is unitarily molded with a main body and a top cover of the container connected by a jointed side; a retaining hole is disposed on the rim side at the top end of the container main body; a retainer is disposed at the bottom end of the top cover opposite the retaining hole; the said retainer can be clamped into the retainer hole for covering the top cover onto the container main body; the present invention is characterized that the jointed side is a plane with more than one permeability holes disposed thereon for increasing the permeability of the entire food container.

2. A food container capable of increasing the effect of air permeability according to claim 1, wherein a plurality of slot holes are disposed on the bottom portion of the container main body; two sides of the slot hole are disposed with a flange protruding outwardly, a top end of the slot hole is disposed with a convex post protruding outwardly and a concave slot is disposed between two adjacent convex posts to enable an inner and an outer rims of the container main body to form a concavo-convex structure; in addition to the slot hole for draining the moisture inside the container outwardly, a concavo-convex structure on the peripheral rim can also prevent the food inside the container from being touched by the holder's hand so as to prevent the rottenness and always remain the freshness of the fruit.

3. A food container capable of increasing the effect of air permeability according to claim 1, wherein a convex block is respectively disposed on four corner ends at the top end of the container main body; four end corners at the bottom end of the top cover are also disposed with corresponding convex block; when the top cover is covered onto the container main body, the convex block on the top cover and the convex block on the container main body are superposed together to form a plurality of hollows at two ends and a front rim of the container for increasing the permeability of the covered container.

4. A food container capable of increasing the effect of air permeability according to claim 1, wherein the slot hole at the bottom portion of the container main body is in a longitudinal L-shape.

5. A food container capable of increasing the effect of air permeability according to claim 1, wherein a retaining hole of the container main body is located inside the convex block on the front rim thereof; the retainer of the top cover is located on the convex block of the front rim thereof.

6. A food container capable of increasing the effect of air permeability according to claim 1, wherein a supporting block is disposed at the center of the front rim at the top end of the container main boy; the receiving slot at the center of the front rim on the bottom portion of the top cover is provided for receiving the supporting block.
